(19) United States
(12) Patent Application Publication
(10) Pub. No.: US 2026/0355690 A1
(43) Pub. Date: Nov. 12, 2026

(54) FILTER WITH INCREASED FILTRATION EFFICIENCY

(71) Applicant: UMICORE AG & CO. KG, Hanau-Wolfgang (DE)

(72) Inventors: Johannes SCHUEHLE, Hanau (DE); Meike GOTTHARDT, Frankfurt (DE); Jan SCHOENHABER, Darmstadt (DE); Carolin BRAUN, Langen (DE)

(73) Assignee: UMICORE AG & CO. KG, Hanau-Wolfgang (DE)

(21) Appl. No.: 19/286,128

(22) Filed: Jul. 30, 2025

(30) Foreign Application Priority Data
Aug. 1, 2024 (DE) 102024121910.6

(51) Int. Cl. B01D 53/94; B01J 23/10; B01J 23/44; B01J 23/46; B01J 35/56; B01J 37/02; B01J 37/08; F01N 3/022; F01N 3/035; F01N 3/10; F01N 3/20

(52) U.S. Cl. CPC B01D 53/9477; B01J 23/10; B01J 23/44; B01J 23/464; B01J 35/56; B01J 37/0228; B01J 37/0236; B01J 37/08; F01N 3/022; F01N 3/035; F01N 3/101; F01N 3/106; F01N 3/2066; B01D 2255/1023; B01D 2255/1025; B01D 2255/2063; B01D 2255/908; B01D 2255/9155; B01D 2258/014; F01N 2510/063; F01N 2510/068

(57) ABSTRACT

The present invention relates to a method for manufacturing particulate filters for use in exhaust gas applications. In particular, it concerns so-called wall-flow filter substrates which are coated with a dry ceramic powder in the inlet area. A corresponding filter or an exhaust gas system containing the filter and its use in a method for exhaust gas purification are also disclosed.

The present invention relates to a method for manufacturing particulate filters for use in exhaust gas applications. In particular, it concerns so-called wall-flow filter substrates which are coated with a dry ceramic powder in the inlet area. A corresponding filter or an exhaust gas system containing the filter and its use in a method for exhaust gas purification are also disclosed.

The exhaust gas from internal combustion engines in motor vehicles typically contains the harmful gases carbon monoxide (CO) and hydrocarbons (HC), nitrogen oxides (NOₓ) and possibly sulfur oxides (SOₓ), as well as particles consisting largely of solid carbonaceous particles and possibly adhering organic agglomerates. They are referred to as primary emissions. CO, HC, and particles are products of incomplete combustion of the fuel in the combustion chamber of the engine. Nitrogen oxides are formed in the cylinder from nitrogen and oxygen of the intake air when the combustion temperatures exceed 1200 °C. Sulfur oxides result from the combustion of organic sulfur compounds, which are always contained in small quantities in non-synthetic fuels. Compliance with regulatory emission limits applicable to motor vehicles in Europe, China, North America, and India in the future requires extensive removal of the mentioned pollutants from the exhaust gas. For removing these emissions, which are harmful to the environment and health, from the exhaust gases of motor vehicles, a variety of catalytic exhaust gas cleaning technologies have been developed, the basic principle of which is usually based on conducting the exhaust gas to be cleaned over a flow-through or a wall-flow honeycomb body with a catalytically active coating applied thereto. The catalyst promotes the chemical reaction of various exhaust gas components to form harmless products, such as carbon dioxide, water, and nitrogen. For removing particle emissions, diesel particulate filters (DPF) or gasoline particulate filters (GPF)/Otto particulate filters (OPF) with and without an additional catalytically active coating are suitable aggregates.

The flow-through or wall-flow honeycomb bodies described above are also referred to as catalyst carriers, carriers, substrates, or substrate monoliths since they carry the catalytically active coating on their surface or in the walls forming this surface. The catalytically active coating is often applied in the form of a suspension to the catalyst carrier in a so-called coating process. Many such processes have been published by car exhaust catalyst manufacturers in the past (EP1064094B1, EP2521618B1, WO10015573A2, EP1136462B1, U.S. Pat. No. 6,478,874B1, U.S. Pat. No. 4,609,563A, WO9947260A1, JP5378659B2, EP2415522A1, JP2014205108A2).

Exhaust gases from internal combustion engines operated with a predominantly (>50% of the operating time) stoichiometric air/fuel mixture, i.e., for gasoline engines operated with gasoline or natural gas, are cleaned in conventional methods using three-way catalysts (TWC). These catalysts are capable of simultaneously converting the three major gaseous pollutants of the engine, namely, hydrocarbons, carbon monoxide and nitrogen oxides, into harmless components. Stoichiometric means that, on average, the amount of air available to burn the fuel present in the cylinder is exactly the amount of air needed for complete combustion. The combustion air ratio λ (A/F ratio; air/fuel ratio) sets the mass of air m_{L,tats} actually available for combustion in relation to the stoichiometric mass of air m_{L,st}:

$$λ = \frac{{m}_{L , tats}}{{m}_{L , st}}$$

If λ<1 (e.g., 0.9), this means “deficient air” and is referred to as a rich exhaust gas mixture; A λ1 (e.g., 1.1) means “excess air” and the exhaust gas mixture is referred to as lean. The statement λ=1.1 means that 10% more air is present than would be necessary for the stoichiometric reaction. The same applies to exhaust gas from internal combustion engines.

As catalytically active materials, platinum group metals, in particular platinum, palladium, and rhodium, which are, for example, present on γ aluminum oxide as the carrier material, are generally used in the known three-way catalysts. In addition, three-way catalysts contain oxygen storage materials, for example cerium/zirconium mixed oxides. In the latter, cerium oxide, a rare earth metal oxide, is the basic component for oxygen storage. In addition to zirconium oxide and cerium oxide, these materials may contain additional constituents such as further rare earth metal oxides or alkaline earth metal oxides. Oxygen storage materials are activated by applying catalytically active materials such as platinum group metals and thus also serve as a carrier material for the platinum group metals.

Oxidation catalysts usually contain the precious metals platinum or palladium. These are dispersed on high-surface metal oxides such as γaluminum oxide as a carrier material. For complying with the regulatory standards, it may be desirable for current and future applications for exhaust gas aftertreatment of internal combustion engines for cost reasons but also for installation space reasons to combine particulate filters with catalytically active functionalities. The use of a particulate filter, whether catalytically coated or not, results in a noticeable increase in exhaust gas backpressure in comparison to a flow-through carrier of the same dimensions and thus to a reduction in engine torque or possibly increased fuel consumption. In order not to further increase the exhaust gas backpressure, the quantities of oxidic carrier materials for the catalytically active elements of the catalyst or oxidic catalyst materials are generally applied to a filter in smaller amounts than to a flow-through carrier. There has already been some effort to provide particulate filters that have good catalytic activity through an active coating while still exhibiting the lowest possible exhaust gas backpressure. With regard to low exhaust gas backpressure, it has been shown to be favorable, for example, if the catalytically active coating is not located as a layer on the channel walls of a porous wall-flow filter, but rather the channel walls of the filter are interspersed with the catalytically active material, see, for example, WO2005016497A1, JPH01-151706, and EP1789190B1. For this purpose, the particle size of the catalytic coating is selected such that the particles can penetrate into the pores of the wall-flow filters and be fixed there by calcining. A disadvantage of catalytically active filters with an in-wall coating is that the quantity of catalytically effective substance is limited by the holding capacity of the porous wall.

It has been shown that applying the catalytically active substances to the surfaces of the channel walls of a wall-flow honeycomb body can achieve an increase in the conversion of the pollutants in the exhaust gas. Combinations of both on-wall and in-wall coatings with catalytically active material are also possible, which can further increase catalytic performance without significantly increasing the dynamic pressure (EP3501648A1).

In addition to catalytic effectiveness, a further functionality of the filter that can be improved by a coating is its filtration efficiency, i.e., the filtering effect itself. WO2011151711A1 describes a method by means of which a dry aerosol is applied to a non-coated or catalytically coated filter carrying the catalytically active material in the channel walls (in-wall coating with washcoat). The aerosol is provided through the distribution of a powdered mineral material and is passed over the inlet side of a wall-flow filter by means of a gas stream. In the process, the individual particles with a particle size of 0.2 μm to 5 μm agglomerate to form a bridged network of particles and are deposited as a layer on the surface of the individual inlet channels extending through the wall-flow filter. The typical loading of a filter with the powder is between 5 g and 50 g per liter of filter volume. It is expressly noted that it is undesirable to use the metal oxide to achieve a coating in the pores of the wall-flow filter.

A further method for increasing the filtration efficiency of catalytically inactive filters is described in WO2012030534A1. In this case, a filtration layer (“discriminating layer”) is generated on the walls of the flow channels of the inlet side by depositing ceramic particles via a particle aerosol. The layers consist of oxides of zirconium, aluminum, or silicon, preferably in fiber form from 1 nm to 5 μm in length and have a layer thickness of more than 10 μm, generally 25 μm to 75 μm. After the coating process, the applied powder particles are calcined in a heat process.

A further method, in which a membrane (“trapping layer”) is generated on the surfaces of the inlet channels of filters in order to increase the filtration efficiency of catalytically inactive wall-flow filters, is described in patent specification U.S. Pat. No. 8,277,880B2. The filtration membrane on the surfaces of the inlet channels is realized by suctioning through a gas stream loaded with ceramic particles (e.g., silicon carbide or cordierite). After application of the filter layer, the honeycomb body is burned at temperatures of greater than 1000 °C in order to increase the adhesive strength of the powder layer on the channel walls. EP2502661A2 and EP2502662B1 mention further on-wall coatings through powder application.

A coating within the pores of a wall-flow filter substrate by means of atomization of dry particles is described in U.S. Pat. No. 8,388,721B2. In this case, however, the powder is to penetrate deeply into the pores. 20% to 60% of the surface of the wall is to remain accessible to soot particles, thus open. Depending on the flow rate of the powder-gas mixture, a more or less strong powder gradient can be adjusted between the inlet side and the outlet side. The pores of the channel walls of the filter coated with powder in the pores according to U.S. Pat. No. 8,388,721B2 can subsequently be coated with a catalytically active component. Here, too, the catalytically active material is located in the channel walls of the filter.

The introduction of the powder into the pores, for example by means of an aerosol generator, is described in EP2727640A1. Here, a non-catalytically coated wall-flow filter is coated with a gas stream containing, for example, aluminum oxide particles, in such a way that the complete particles, which have a particle size of 0.1 μm to 5 μm, are deposited as a porous filling in the pores of the wall-flow filter. The particles themselves can realize a further functionality of the filter in addition to the filtering effect. By way of example, these particles are deposited in the pores of the filter in an amount of more than 80 g/L in relation to the filter volume. They fill 10% to 50% of the volume of the filled pores in the channel walls. Both when loaded with soot and without soot, this filter has improved filtration efficiency in comparison to the untreated filter at a lower exhaust gas backpressure of the soot-laden filter.

In WO2018115900A1, wall-flow filters are coated with a possibly dry synthetic ash in such a way that a continuous membrane layer is formed on the walls of the possibly catalytically coated wall-flow filter.

Applying dry powders to the filter inlet side generally results in increased filtration efficiency with only a moderate increase in exhaust gas counterpressure. However, these powders do not bind firmly to the wall surface of the filter on which they are deposited. They can therefore be easily washed out by condensation water present in the exhaust gas stream, which reduces the filtration efficiency of the wall-flow filter during continued use.

WO2023026022A1 relates to a method for forming an inorganic oxide coating on a wall-flow filter suitable for treating exhaust gas. In particular, the method comprises spraying inorganic particles and a silicone resin as a dry particulate aerosol to form a coating layer. According to this document, a powder mixture of silicone resin and inorganic particles is formed, which is then sprayed together onto a corresponding filter, which is subsequently calcined.

WO2020047708A1 describes a wall-flow filter comprising a porous ceramic honeycomb structure having a first end, a second end, and a plurality of walls with porous wall surfaces defining a plurality of internal channels, wherein a porous inorganic material disposed on one or more of the wall surfaces is bonded to the wall-flow filter by, inter alia, silicone resin-containing binders. A solution containing the silicone resin is brought into contact with the porous material in a solvent and then the porous material is atomized onto the filter while the solvent is evaporated. Finally, the organic material is burned out of the filter. The procedure described here produces undefined aggregates or agglomerates of primary particles of varying sizes during the evaporation of the solvent, which then preferentially deposit on the wall of the wall-flow filter.

Both of the above-mentioned publications have in common that the addition of silicone resin improves the adhesion of the powder to the wall surface of the particulate filter. However, the other desired properties of such a filter substrate for exhaust gas aftertreatment must not be lost sight of. There is therefore still a need for catalytically coated wall-flow filters, which are further optimized in terms of their filtration efficiency, exhaust gas counterpressure, and any catalytic effectiveness. Care should also be taken to ensure that the powder layer adheres as effectively as possible to or in the wall surface of the wall-flow filter so that the filter effect can be maintained at a consistently high level even after prolonged operation.

These and other tasks apparent to the person skilled in the art from the prior art are solved by a method for manufacturing a particulate filter with the features of the present claim 1. Claims 2-8 relate to preferred embodiments of the method. Claim 9 relates to a particulate filter manufactured according to the invention. Claims 9-13 relate to preferred embodiments of the particulate filter. Claims 14-16 relate to a corresponding exhaust system and claims 17 and 18 relate to the use of the particulate filter or the system for exhaust gas purification.

In a method for manufacturing a catalytically active particulate filter comprising a wall-flow filter substrate for reducing harmful components from the exhaust gas of internal combustion engines, wherein the wall-flow filter substrate has a length L and channels E and A which extend parallel between a first and a second end of the wall-flow filter substrate, which are separated by porous walls and form surfaces OE and OA, respectively, and wherein the channels E at the second end and the channels A at the first end are closed, wherein a first step, a dry powder comprising refractory metal compound particles coated with a silicone resin is produced; and in a second, separate step, the surfaces OE of the catalytically active filter are coated with a dry powder-gas aerosol containing the powder from the first step; and in a third step, the filter together with the powder is heated so that organic components are removed from the filter. A corresponding particulate filter is shown in FIG. 2. The main improvement of the present invention over the prior art methods is that a more defined powder silicone resin aerosol can be provided for the coating and is thus able to set defined filter properties. This allows the dry powder particles coated with silicone resin to be standardized in terms of their size before being applied to the filter in order to achieve a more optimal coating of the filter with the powder gas aerosol. The process is also more robust as, for example, the degree of drying of the powder-silicone resin mixture can be set more precisely before the corresponding aerosol is atomized onto the filter. For example, the semi-dry powder does not stick to the device walls and does not have to be removed from them from time to time. This helps to save maintenance costs.

All ceramic wall-flow filter substrates known from the prior art and common in the field of car exhaust gas catalysis can be used as wall-flow substrate. Porous wall-flow filter substrates made of cordierite, silicon carbide, or aluminum titanate are preferably used. These wall-flow filter substrates have channels E and channels A, which function as described above as input channels, which may also be referred to as inflow-side channels, and as output channels, which may also be referred to as outflow-side channels. The outflow-side ends of the inflow-side channels and the inflow-side ends of the outflow-side channels are closed with generally gas-tight “plugs” in a manner offset from one another. In this case, the exhaust gas to be cleaned, which flows through the filter substrate, is forced to pass through the porous wall between the inflow-side and the outflow-side channel, which causes a particulate filtering effect. The porosity, pore/radius distribution, and thickness of the wall allow the filtration property to be designed for particles. According to the invention, the porosity of the uncoated wall-flow filter substrates is generally more than 40%, for example from 40% to 75%, particularly from 50% to 70% [measured according to DIN 66133, latest version on the filing date]. The average pore size d₅₀ of the uncoated wall-flow filter substrates is at least 4 μm, for example from 4 μm to 34 μm, preferably more than 6 μm, in particular more preferably from 6 μm to 25 μm, or most preferably from 7 μm to 17 μm [measured according to DIN 66,134 latest version on the filing date], wherein the d₅₀ value of the pore size distribution of the wall-flow filter substrate is understood to mean that 50% of the total pore volume that can be determined by mercury porosimetry is formed by pores whose diameter is less than or equal to the value specified as d₅₀.

The powder has refractory metal compounds and advantageously does not contain any precious metal. It is thus preferably not catalytically active in the sense of the present invention. In particular, it is substantially unable to oxidize carbonaceous particles such as soot or volatile hydrocarbon particles or to oxidize the exhaust gas components CO and HC or to reduce NOx. The powder thus preferably consists of ceramic or oxidic constituents and does not contain any further catalytic components. Particularly suitable components of the powder are refractory metal compound particles selected from the group consisting of aluminum oxide, zirconium dioxide, cerium oxide, yttrium oxide, mullite, tin oxide, silicon nitride, zeolite, titanium dioxide, silicon dioxide, aluminum titanate, silicon carbide, cordierite, island silicates, layer silicates, technical silicates, chain silicates, group silicates, or mixtures thereof.

Powder particles with a tapped density of between 50 g/L and 900 g/L, preferably between 200 g/L and 850 g/L and most preferably between 400 g/L and 800 g/L, can preferably be used for a filtration efficiency-enhancing coating. The term “filtration-increasing” is understood according to the invention to mean that, through the powder coating, the wall-flow filter obtains the ability to retain particles from the exhaust gas stream better than the original filter, without the exhaust gas backpressure increasing exorbitantly in comparison to the starting substrate. Preferably, this means that the filtration efficiency of the filter increases by more than 2 percentage points, more preferably by more than 5 percentage points, and most particularly preferably by more than 10 percentage points in comparison to the starting substrate, without the exhaust gas backpressure increasing by more than 60%, preferably less than 50%, and most preferably less than 40%, in comparison to the starting substrate.

The increase in the filtration efficiency of the filter with powder coating in comparison to the raw filter is calculated according to the following formula:

FE increase through powder coating>/=(100%−FE_{before F})×increase factor

Wherein the increase factor in the case according to the invention is in the range of 0.2-0.99, preferably in the range of 0.35-0.95, and particularly preferably in the range of 0.5-0.85. This is in particular advantageous for filter substrates that already have high filtration performance in the starting substrate.

The increase in the exhaust gas backpressure can be calculated according to the following formula:

Increase in counterpressure due to powder coating=((counterpressure with powder coating/counterpressure without powder coating)−1)×100

However, the increase in exhaust counterpressure remains rather moderate due to the powder coating. The increase should be <30%, preferably <20%.

The powder coating comprising refractory metal compound particles preferably has a monomodal, or a multimodal or broad Q3 particle size distribution. For the definition of the particle size distribution or grain size distribution of the coating, a distinction is made depending on the method by means of which the quantity of the particles is determined, inter alia between number-related (q0) and volume-related (q3) particle size distributions (M. Stiess, Mechanische Verfahrenstechnik—Partikeltechnologie 1 [Mechanical Process Technology—Particle Technology 1], Springer, 3rd edition 2009, page 29). The powder coating on the porous walls of the wall-flow filter substrate has a D₅₀-value of the particle size distribution of the membrane particles (Q3; DIN 66143-latest version on the date of filing), which is advantageously equal to or smaller than the d₅₀ value of the pore size distribution of the wall-flow filter substrate (Q3; measured according to DIN 66133-latest version on the date of filing). The refractory metal compound particles preferably have an average particle diameter of 0.1 μm-20 μm, more preferably 0.2 μm-10 μm, and most preferably 0.3 μm-5 μm (D50; Q3 distribution).

The average pore size d₅₀ of the powder coating is at least 50 nm, for example 50 nm to 5 μm, preferably more than 100 nm to 4 μm, in particular more preferably 200 nm μm to 2.5 μm, wherein the d₅₀ value of the pore size distribution is understood to mean that 50% of the total pore volume that can be determined by mercury porosimetry is formed by pores whose diameter is less than or equal to the value specified as d₅₀. The values are determined as specified above.

The BET surface area of the silicone resin-coated powder is at least 85 m²/g, for example 85 m²/g to 210 m²/g, preferably more than 100 m²/g to 200 m²/g, in particular more preferably 120 m²/g to 180 m²/g.

According to the invention, the powder comprising the refractory metal compound particles is treated, preferably coated, with a silicone resin. This is advantageously achieved by bringing the powder into contact with a solvent in which the resin is dissolved and then drying it. After drying, the individual powder components are preferably present in such a way that the primary particles are coated with a dry silicone resin. It is preferable if the refractory metal compound particles do not bond with each other and form larger secondary particles. In particular, these should not be aggregated or agglomerated with each other. The degree of agglomerated/aggregated particles is less than 25%, preferably less than 10% of the total mass of correspondingly treated or coated powder particles. If necessary, the agglomerated/aggregated particles are deagglomerated/deaggregated in advance by special processes known to the person skilled in the art (e.g., by using shearing forces, such as baffle plates). In addition, particles that are too large can also be easily removed from the powder. In addition to a more defined size distribution of the particles, which allows a better generation of a powder-gas aerosol, it is also possible to convey the powder particles preferentially into the surface pores of the wall-flow filter and not only deposit them on the wall surface. The result is ultimately better adhesion of the powder to the wall of the wall-flow filter.

As already mentioned, the exposure, preferably the coating of the metal compound particles, is preferably carried out in such a way that the powder particles are brought together with the silicone resin in a solvent suspension and the solvent is then evaporated, preferably in such a way that as few agglomerates/aggregates as possible are formed. The easiest way to do this on a large scale is in a so-called spray-drying process. Such methods are known to the person skilled in the art (https://de.wikipedia.org/w/index.php?title=Spr % C3% BChtrocknung&oldid=229912829). Spray drying also helps to avoid the formation of large aggregates or agglomerates of powder particles. Finally, the primary particles are preferably treated or coated with the dry silicone resin. It is therefore particularly preferable for this method step to take place in a spray dryer. The dry powder particles or a more defined fraction thereof with a preferred particle size distribution can then be used for powder coating of the wall-flow filter.

Silicone resins belong to the class of organopolysiloxanes and consist of an irregular, three-dimensional network of mainly tri- or tetrafunctional units. Thanks to the high Si—O bond energy, the various organopolysiloxane types are very stable. Silicone resins can be combined very well with organic polymers. This means that many properties such as cross-linking behavior, flexibility, adhesive properties, or weather resistance can be adjusted as required (https://spiegato.com/de/was-ist-silikonharz). The person skilled in the art knows the silicone resins that can be used to advantage here (https://de.wikipedia.org/w/index.php?title=Silikonharzlack&oldid=225671739). These are commercially available (https://www.wacker.com/cms/de-de/products/product-groups/silicone-resins/silicone-resins.html; https://www.dow.com/documents/de-de/catalog-selection-guide/25-799-silicone-resins-intermediates-selection-guide.pdf?iframe=true). Advantageously, a silicone resin selected from the group consisting of alkyl- or aryl- or alkyl- and aryl-functionalized oligomers or polymeric silicone resins of the formula [A_{w}RₓSiX_{y}O_{z}]ₙ with A as the alkyl group, R as an aryl group, and X as a functional group on the silicon (e.g., hydroxyl, alkoxyl), is used for coating the metal compound particles. Particularly preferred are methyl- and/or phenyl-substituted polymeric silicone resins with hydroxyl functionalities on silicon.

The amount of silicone resin used for the application can be determined by the person skilled in the art. It should be selected so that the powder has sufficient strength on and/or in the filter wall after the final calcination in the filter. This can be determined in routine experiments. Preferably, the powder particles have a mass fraction of silicone resin of 20%-150%, more preferably 50%-130%, and most preferably 80%-120% of the total weight of the refractory metal compound particles.

The solvent used in the present case can be determined by the person skilled in the art. As a rule, it is an organic solvent, as the silicone resins are readily soluble in it. Alternatively, however, water can also be used if water-soluble silicone compounds are used or the silicone resins can be dispersed in water with additives. The person skilled in the art knows how to proceed here. Preferably, one or more solvents selected from the group consisting of EtOH, MeOH, isopropanol, toluene, benzene, acetone, tetrahydrofuran, xylene, ethyl acetate, methyl isobutyl ketone, 2-butanone, dimethyl sulfoxide, ether, and ester are suitable. EtOH, MeOH, isopropanol, and acetone are particularly preferred. Mixtures can also be used.

After the dry powder particles coated with silicone resin have been generated, they are transferred to the wall-flow filter in a subsequent step that is independent of the production of the powder particles. This is achieved by atomizing the powder particles in a gas stream, which is then passed through the catalytically active wall-flow filter (e.g., EP3595796A1). Separating the steps for producing the dry powder particles coated with silicone resin and coating the wall-flow filter with it has the advantage that specific sizes of the powder particles can be fed into the filter. On the one hand, the desired sizes can be set precisely in the first method step. In addition, special size ranges can be selected from the powder particles produced or aggregated/agglomerated particle clusters can be deagglomerated, if necessary and desired. The properties of the wall-flow filter can be better adjusted by decoupling the production of the charged or coated powder particles and their introduction into a wall-flow filter. The specifically produced powder particles and the speed at which they are introduced allow the subsequent filtration efficiency and the exhaust counterpressure of the particulate filter to be adjusted.

It is advantageous to use a method in which these powder particles are dispersed in a gas and this aerosol is introduced into a gas flow in order to subsequently allow the powder-gas aerosol to flow into the wall-flow filter. The person skilled in the art knows how to proceed here (DE102018111246A1, WO2011151711A1, WO2021028691A1 and the literature cited therein). In a preferred method sequence, the powder particles in the gas flow are accelerated into the wall-flow filter in such a way that the particles penetrate into the pores of the channel walls and form a loose mixture there. Preferably, the powder gas aerosol enters or is sucked into the filter at a speed of 10 m/s-50 m/s, preferably 10 m/s-20 m/s. This is particularly preferred in an apparatus as described in DE102018111246A1. The boundary conditions and preferred embodiments described there also apply mutatis mutandis here.

In a final method step, the wall-flow filter produced in this way is heated. Organic components of the silicone resin are removed from the filter, and the silicate matrix that forms binds the powder particles to each other and to or into the wall of the wall-flow filter. Treated in this way, the powder particles can no longer be removed from the wall-flow filter by water collected from the combustion of fuel in the exhaust tract. The powder therefore remains in place and gives the wall-flow filter produced in this way its beneficial properties over a long period of time.

The thermal treatment of the wall-flow filter loaded with the powder material is carried out according to the requirements of the person skilled in the art. For this purpose, the wall-flow filter can, for example, be heated to elevated temperatures in a designated oven, in particular a convection oven, for a certain period of time, possibly in a specific gas atmosphere, until the organic components have volatilized from the silicone resin. As a rule, the thermal fixation of the powder particles takes place at 400-800 °C, preferably at 500-600 °C. The duration of the thermal fixation is generally 1-4 hrs., preferably 2-3 hrs.

In a further embodiment, the present invention also relates to a catalytically active particulate filter manufactured according to the method just described. The particulate filter according to the invention differs from those of the prior art. At the very least, the particulate filter should have a larger mass of powder particles in the wall, since—as already mentioned—primary particles are preferably transported into the wall-flow filter and preferably no agglomerates or aggregates of these. In a preferred embodiment the powder is located with at least 30% of the total mass of the powder in the porous walls of the wall-flow filter substrate. More preferably with at least 40% and very preferably with up to 60% or up to 50% of the total mass. The powder particles therefore penetrate the porous filter wall. However, the penetration depth is preferably limited. The penetration depth of the powder particles into the filter wall is on average of all particles a maximum of 50% of the wall thickness, preferably a maximum of 40%, and most preferably a maximum of 25%. The provisions for this can be made analogously DE102018111246A1 by means of corresponding recordings.

The person skilled in the art can atomize any amount of powder into the wall-flow filter. A certain value should not be undershot, otherwise the desired filtration efficiency will not be achieved. If the load is set too high, the exhaust counterpressure increases accordingly. If the powder is, for example, pyrogenically produced metal oxides, then the loading of the wall-flow filter with the powder particles can be less than 1 g/L, preferably less than 0.5 g/L. In the case of other, non-pyrogenically produced metal compounds, the quantity of powder particles in the wall-flow filter is up to 50 g/L, based on the volume of the wall-flow filter substrate, preferably up to 30 g/L, and most preferably up to 25 g/L. A lower limit is found here at 1 g/L.

The catalytically active particulate filter according to the invention is characterized in that it comprises a powder thermally fixed with silicates and having refractory metal compound particles on or in the input surface O_{E} of the filter. Corresponding powder particles have been applied to the wall-flow filter by a coating process in which a powder-gas aerosol has been introduced into the filter. As a result, the powder particles are found at least in the surface pores of the wall-flow filter. The powder particles can fill the pores right up to the edge of the wall surface O_{E}. It is also possible, however, that more powder particles are introduced into the wall-flow filter, so that the powder particles also start to collect on the surface O_{E}. However, a completely continuous surface coating with the powder particles should preferably be avoided. It is therefore preferred if the powder does not form a coherent coating on the surfaces of O_{E}.

The particulate filter has been provided with a catalytically active compound before being exposed to the powder. This may have been applied to the filter in the form of a washcoat according to a known pattern. The catalytic coating can be located on the surfaces O_{E} or O_{A} and/or be present in the wall of the filter. The catalytically active coating can be zoned. A length of 30%-90%, preferably 50-80% of the coatable filter length L is preferred here. This applies in particular to a coating on the walls O_{E} and/or O_{A} (each measured from the end of the particulate filter).

The catalytically active coating may have an activity suitable to the person skilled in the art for the present purpose. In the context of the present invention, “catalytically active” means the ability to convert harmful components of the exhaust gas from internal combustion engines into less harmful ones. In particular, the exhaust gas components NOx, CO, and HC should be mentioned here. The catalysts that may preferably be considered in the present case are those selected from the group consisting of three-way catalyst, oxidation catalyst, NOₓ storage catalyst, hydrocarbon trap, SCR catalyst, ammonia slip catalyst. In the present case, a coating that is three-way catalytically active, particularly at operating temperatures of 250 to 1100 °C, is particularly preferred. This coating preferably contains the precious metals palladium and/or rhodium, wherein platinum is also present as a further precious metal only in exceptional cases. Particularly preferably, the coating contains palladium and rhodium and no platinum. In a further embodiment, the coating contains the precious metals platinum and/or rhodium, wherein palladium is also present only by way of exception as a further precious metal. In a further embodiment, the coating contains the precious metals platinum, palladium, and/or rhodium. In this embodiment, it is advantageous if the mass ratio of platinum to palladium is 15:1 to 1:15, in particular 10:1 to 1:10. In relation to the particulate filter according to the invention, the proportion of rhodium in the total precious metal content is in particular greater than or equal to 5% by weight, preferably greater than or equal to 10% by weight. For example, the proportion of rhodium in the total precious metal content is 5% to 20% by weight or 5% to 15% by weight. The precious metals are usually used in quantities of 0.10 to 5 g/L, based on the volume of the wall-flow filter substrate.

The precious metals are usually fixed to one or more carrier materials. All materials known to the person skilled in the art for this purpose can be considered as carrier materials. Such materials are in particular metal oxides with a BET surface area of 30 to 250 m²/g, preferably 100 to 200 m²/g (determined according to DIN 66132-latest version on the filing date). Particularly suitable carrier materials for the precious metals are selected from the series consisting of aluminum oxide, doped aluminum oxide, silicon oxide, titanium dioxide, and mixed oxides of one or more of these. Doped aluminum oxides are, for example, lanthanum oxide, zirconium oxide, barium oxide, and/or titanium oxide-doped aluminum oxides. Aluminum oxide or lanthanum-stabilized aluminum oxide is advantageously used, wherein in the latter case lanthanum is used in quantities of in particular 1 to 10 wt. %, preferably 3 to 6 wt. %, in each case calculated as La₂O₃ and based on the weight of the stabilized aluminum oxide.

For three-way activity, it is preferable if a cerium/zirconium mixed oxide is also present as a carrier material for the precious metals. Preferred cerium/zirconium mixed oxides comprise one or more rare earth metal oxides and can thus be referred to as cerium/zirconium/rare earth metal mixed oxides. The term “cerium/zirconium/rare earth metal mixed oxide” within the meaning of the present invention excludes physical mixtures of cerium oxide, zirconium oxide, and rare earth oxide. Rather, “cerium/zirconium/rare earth metal mixed oxides” are characterized by a largely homogeneous, three-dimensional crystal structure that is ideally free of phases of pure cerium oxide, zirconium oxide, or rare earth oxide (solid solution). Depending on the manufacturing process, products that are not completely homogeneous can also be produced, which can generally be used without disadvantages. The same applies to cerium/zirconium mixed oxides that do not contain rare earth oxide. Moreover, the term rare earth metal or rare earth metal oxide in the sense of the present invention does not include cerium or cerium oxide.

Examples of rare earth metal oxides in the cerium/zirconium/rare earth metal mixed oxides are lanthanum oxide, yttrium oxide, praseodymium oxide, neodymium oxide, and/or samarium oxide. Preferred are lanthanum oxide, yttrium oxide, and/or praseodymium oxide. Lanthanum oxide and/or yttrium oxide are particularly preferred, and lanthanum oxide and yttrium oxide, yttrium oxide and praseodymium oxide, and lanthanum oxide and praseodymium oxide are particularly preferred. In embodiments of the present invention, the oxygen storage components are free of neodymium oxide. The proportion of rare earth metal oxide in the cerium/zirconium/rare earth metal mixed oxides is in particular 3 to 20% by weight relative to the cerium/zirconium/rare earth metal mixed oxide.

If the cerium/zirconium/rare earth metal mixed oxides contain yttrium oxide as a rare earth metal, its content is preferably 4 to 15% by weight relative to the cerium/zirconium/rare earth metal mixed oxide. If the cerium/zirconium/rare earth metal mixed oxides contain praseodymium oxide as a rare earth metal, its content is preferably 2 to 10% by weight relative to the cerium/zirconium/rare earth metal mixed oxide. If the cerium/zirconium/rare earth metal mixed oxides contain lanthanum oxide and another rare earth oxide as the rare earth metal, such as yttrium oxide or praseodymium oxide, their mass ratio is in particular 0.1 to 1.25, preferably 0.1 to 1.

The coating usually contains oxygen storage components in quantities of 15 to 120 g/L, based on the volume of the wall-flow filter substrate. The mass ratio of carrier materials and oxygen storage components in the coating is usually 0.25 to 1.5, for example 0.3 to 1.3. For example, the weight ratio of the sum of the masses of all aluminum oxides (including doped aluminum oxides) to the sum of the masses of all cerium/zirconium mixed oxides in coating Z is 10:90 to 75:25.

In embodiments of the present invention, the coating comprises lanthanum-stabilized alumina, rhodium, palladium, or palladium and rhodium, and a cerium/zirconium/rare earth metal mixed oxide containing yttrium oxide and lanthanum oxide as rare earth metal oxides. In other embodiments of the present invention, the coating comprises lanthanum-stabilized alumina, rhodium, palladium, or palladium and rhodium, and a cerium/zirconium/rare earth metal mixed oxide containing praseodymium oxide and lanthanum oxide as rare earth metal oxides. In other embodiments of the present invention, the coating comprises lanthanum-stabilized alumina, rhodium, palladium, or palladium and rhodium, a cerium/zirconium/rare earth metal mixed oxide containing praseodymium oxide and lanthanum oxide as rare earth metal oxides, and a second cerium/zirconium/rare earth metal mixed oxide containing yttrium oxide and lanthanum oxide as rare earth metal oxides.

A subject of the present invention is also a system for cleaning exhaust gases from internal combustion engines, in particular from predominantly stoichiometrically operated combustion engines, which system comprises a particulate filter according to the invention. Further preferred is a system for cleaning exhaust gases, which is characterized in that the particulate filter according to the invention is arranged with its first end (the side exposed to the powder forms the inlet area for the exhaust gas) directly downstream of a three-way or oxidation catalytic converter close to the engine. Three-way catalysts or oxidation catalysts are known to the person skilled in the art. Both types oxidize HCs or CO in the exhaust gas to H₂O and CO₂. The three-way catalytic converter can also reduce NOx to N₂ in a stoichiometric exhaust gas environment.

The filter is therefore arranged in the exhaust tract following the exhaust gas as a separate unit downstream of the catalytic converter (close to the engine). In particular, it is advantageous if a three-way catalyst is located in a position close to the engine directly on the inflow side of the wall-flow filter according to the invention. It is also advantageous if a three-way catalyst is located on the outflow side of the wall-flow filter according to the invention. It is also particularly advantageous if a three-way catalyst is located on the inflow side and on the outflow side of the wall-flow filter according to the invention.

Further preferred is in particular a system for cleaning exhaust gases which is characterized in that, after the wall-flow filter according to the invention in the direction of the exhaust gas, there is at least one further catalyst selected from the group of three-way catalyst, oxidation catalyst, NOₓ storage catalyst, hydrocarbon trap, SCR catalyst, ammonia slip catalyst. The preferred embodiments described for the wall-flow filter according to the invention also apply mutatis mutandis to the system mentioned here. Corresponding catalysts are described in the following literature: EP4079399A1, EP4204143A1, EP4072708A1, EP3794221A1, EP3826754A1, EP4126348A1 and the literature cited therein.

A subject of the present invention is also a method for exhaust gas purification of an internal combustion engine, wherein the exhaust gases of the engine are conducted over a particulate filter according to the invention or a system comprising this wall-flow filter. Preferably, the internal combustion engine is one that is predominantly operated stoichiometrically. The preferred and alternative embodiments of the particulate filter according to the invention and of the system also apply mutatis mutandis here. The exhaust gas is guided over the filter so that the inlet side is the side exposed to the powder.

The term “close to the engine” in the sense of the invention refers to an area in the exhaust line that is in a position close to the engine, i.e., approx. 10-80 cm, preferably 20-60 cm, from the engine exit.

In the intended use of the particulate filter according to the invention for the cleaning of exhaust gas from internal combustion engines, the exhaust gas flows into the filter at one end and exits it again at the other end after passing through the porous walls. For example, if the exhaust gas enters the filter at the first end, the channels E denote the input channels or inflow-side channels. After passing through the porous walls, the exhaust gas then exits the filter at the second end so that the channels A denote the output channels or outflow-side channels. L represents the average coatable length of the filter. Due to the plugs at the channel ends, the entire length of the filter does not have to be coated. L represents the sum of the lengths actually available for the coating in the coated channels, averaged over the number of coated channels (FIG. 2).

The particulate filter according to the invention exhibits excellent filtration efficiency with no or only a very slight increase in exhaust counterpressure. The low total backpressure is likely due to the fact that the presence of powder particles does not greatly reduce the cross-section of the channels on the inlet side. It is assumed that powder particle coating forms a porous structure, which has a positive effect on the dynamic pressure. Through this coating, a filter according to the invention also has a lower dynamic pressure after soot loading than an analogous filter without powder particle coating, since this coating largely prevents the soot from penetrating into the porous filter wall. The powder particles do not become detached from the wall of the filter even after prolonged use. An additional catalytic coating, if present, gives the particulate filter according to the invention an excellent catalytic capability.

Dry in the sense of the present invention means the exclusion of the presence of a liquid, in particular water. In particular, the preparation of a suspension of the powder in a liquid for atomization into a gas stream, which is fed directly into the wall-flow filter with or without drying, should be avoided. A certain amount of moisture may be tolerable both for the filter and for the powder particles applied or coated, provided that the achievement of the objective—the most finely distributed deposition of the powder in the porous walls and/or the surfaces O_{E} of the wall-flow filter substrate—is not negatively affected. As a rule, the powder is free-flowing and can be dispersed by applying energy. The presence of a liquid in the dry powder or in the wall-flow filter substrate should be less than 10 wt. %, preferably less than 5 wt. %, and most preferably less than 1 wt. % at the time of exposure to the powder. The person skilled in the art knows how to analytically determine the proportion of liquid in the powder or filter.

The filter according to the invention is usually used primarily in internal combustion engines, in particular in internal combustion engines with direct injection or intake manifold injection. Preferably, these engines are predominantly stoichiometrically operated gasoline or natural-gas engines. Preferably, these engines are turbocharged engines. The requirements for gasoline particulate filters (GPF) differ significantly from the requirements for diesel particulate filters (DPF). Diesel engines without DPF may have up to ten times higher particle emissions, in relation to the particulate mass, than gasoline engines without GPF (Maricq et al., SAE 1999-01-01530). In addition, in gasoline engines, there are significantly fewer primary particles and the secondary particles (agglomerates) are significantly smaller than in diesel engines. The emissions in gasoline engines are in the range of particle sizes of less than 200 nm (Hall et al., SAE 1999-01-3530) to 400 nm (Mathis et al., Atmospheric Environment 38, 4347) with the maximum in the range of about 60 nm to 80 nm. The filtration of the nanoparticles in the GPF must therefore take place mainly via diffusion separation. For particles smaller than 300 nm, as the size decreases, the separation by diffusion (Brownian molecular movement) and electrostatic forces become increasingly important (Hinds, W.: Aerosol technology: Properties and behavior and measurement of airborne particles. Wiley, 2nd edition 1,999). Nevertheless, the wall-flow filter according to the invention may also be used in the diesel sector.

### FIGURES

FIG. 1:

FIG. 1 shows a particulate filter with a first (1) and a second end (2) of the wall-flow filter substrate extending therefrom, which are separated by porous walls (3) and form surfaces O_{E} and O_{A}, respectively, and wherein the channels E at the second end (2) and the channels A at the first end (1) are closed. The flow of exhaust gas through the wall is shown.

FIG. 2:

FIG. 2 shows a particulate filter according to the invention with the surfaces OE and OA. The flow of the exhaust gas through the wall and the powder particle coating (3) is shown. The coatable length L of the wall-flow filter is shown.

FIG. 3:

For comparison, FIG. 3 shows a graph of the filtration efficiency and counterpressure of the comparative examples VGPF1, VGPF2, and VGPF3 as well as the examples GPF1, GPF2, and GPF3.

FIG. 4:

FIG. 4 shows in comparison the enlarged surface O_{E} of a commercially available flow-through filter substrate that has been treated with a filtration-enhancing powder (A) or alternatively with a silicone resin-modified filtration-enhancing powder (C) according to the invention and then thermally treated. B shows surface A after treatment with water, D shows surface C after treatment with water. The red circles are examples of reopened pores in the surface.

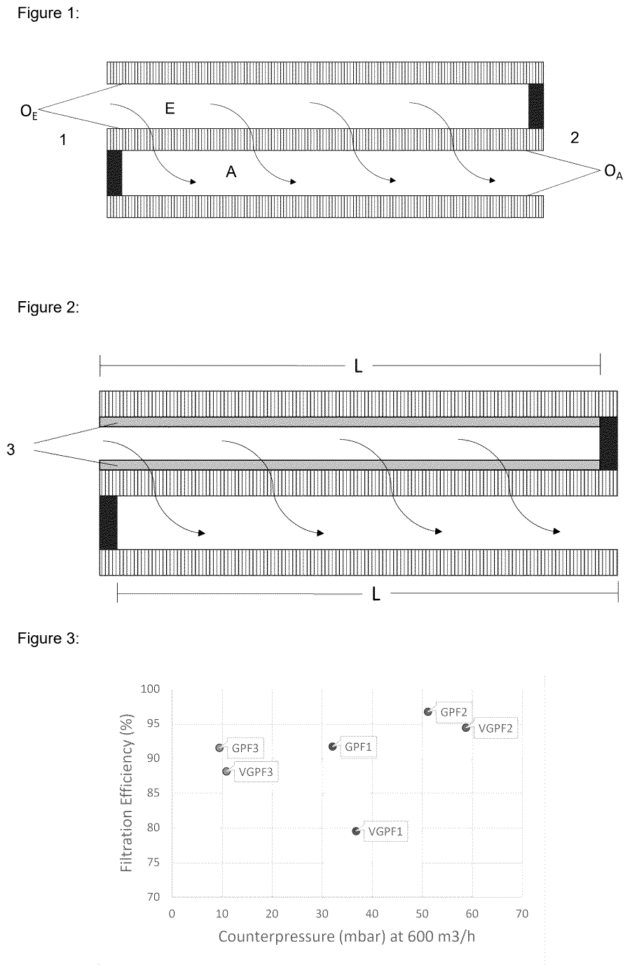

### EXAMPLES

If the particulate filter is coated with a filtration-enhancing powder using a powder-gas aerosol, the coating is applied according to the method described in EP3595796A.

### Comparative Example 1: First, the Porous Wall is Exposed to Filtration-Increasing Powder, then Coated with a Catalytically Active Layer

The surfaces O_{E} of a commercially available flow-through filter substrate were treated with a filtration-enhancing powder and then thermally treated. The total load of the filter with the filtration-enhancing powder was 21 g/L. The O_{A} surfaces were then coated in a wet process as described in the literature with a catalytically active layer containing an oxygen storage component, a lanthanum oxide-stabilized aluminum oxide, and palladium and/or rhodium as catalytically active metals, wherein the coating was applied to over 80% of the substrate length on the porous filter wall O_{A}. The total loading of the filter was 62.5 g/L, the total precious metal loading was 1.67 g/L with a ratio of palladium to rhodium of 3.75:1. The resulting coated filter was dried and then calcined. It is hereinafter referred to as VGPF1.

### Comparative Example 2: Coating with Catalytically Active Layer on Commercially Available Flow-Through Filter Substrate with Filtration-Enhancing Coating

The O_{A} surfaces of a commercially available flow filter substrate with a filtration-enhancing coating were as described in the literature, with a catalytically active layer containing an oxygen storage component, a lanthanum oxide-stabilized aluminum oxide, and palladium and/or rhodium as catalytically active metals in a wet process, wherein the coating was applied to the porous filter wall over 80% of the substrate length. The total loading of the filter was 50 g/L, the total precious metal loading was 1.33 g/L with a ratio of palladium to rhodium of 3.75:1. The resulting coated filter was dried and then calcined. It is referred to below as VGPF2.

### Comparative Example 3: Firstly, the Filter is Exposed to Filtration-Enhancing Powder, then a Catalytically Active Layer is Applied to the Porous Wall of the Flow-Through Filter Substrate

The surfaces O_{E} of a commercially available flow-through filter substrate were treated with a filtration-enhancing powder and then thermally treated. The total load of the filter with the filtration-enhancing powder was 12 g/L. The O_{A} surfaces were then coated in a wet process as described in the literature with a catalytically active layer containing an oxygen storage component, a lanthanum oxide-stabilized aluminum oxide, and platinum and/or rhodium as catalytically active metals, wherein the coating was applied to over 80% of the substrate length in the porous filter wall. The total loading of the filter was 10 g/L, the total precious metal loading was 0.11 g/L with a ratio of platinum to rhodium of 12:1. The resulting coated filter was dried and then calcined. It is referred to below as VGPF3.

### Example 1: First Coating with a Catalytically Active Layer, then Exposure to Filtration-Enhancing Powder

The O_{A} surfaces were coated, as described in the literature, with a catalytically active layer containing an oxygen storage component, a lanthanum oxide-stabilized aluminum oxide, and palladium and/or rhodium as catalytically active metals in a wet process, wherein the coating was applied to over 80% of the substrate length on the porous filter wall. The total loading of the filter was 62.5 g/L, the total precious metal loading was 1.67 g/L with a ratio of palladium to rhodium of 3.75:1. The resulting coated filter was dried and then calcined. The surfaces O_{E} of the calcined filter obtained in this way were treated with a filtration-enhancing powder and then thermally treated. The total loading of the filter with the filtration-enhancing powder was 21 g/L. The filter obtained in this way is referred to below as GPF1.

### Example 2: First Coating with a Catalytically Active Layer, then Exposure to Filtration-Enhancing Powder

The O_{A} surfaces were coated, as described in the literature, with a catalytically active layer containing an oxygen storage component, a lanthanum oxide-stabilized aluminum oxide, and palladium and/or rhodium as catalytically active metals in a wet process, wherein the coating was applied to over 80% of the substrate length on the porous filter wall. The total loading of the filter was 62.5 g/L, the total precious metal loading was 1.67 g/L with a ratio of palladium to rhodium of 3.75:1. The resulting coated filter was dried and then calcined. The surfaces O_{E} of the calcined filter obtained in this way were treated with a filtration-enhancing powder and then thermally treated. The total loading of the filter with the filtration-enhancing powder was 3 g/L. The filter obtained in this way is referred to below as GPF2.

### Example 3: Coating with Catalytically Active Layer in the Porous Wall of the Flow-Through Filter Substrate and Subsequent Application of Filtration-Enhancing Powder

The O_{A} surfaces of a commercially available flow filter substrate were as described in the literature, with a catalytically active layer containing an oxygen storage component, a lanthanum oxide-stabilized aluminum oxide, and platinum and/or rhodium as catalytically active metals in a wet process, wherein the coating was applied over 80% of the substrate length into the porous filter wall. The total loading of the filter was 10 g/L, the total precious metal loading was 0.11 g/L with a ratio of platinum to rhodium of 12:1. The resulting coated filter was dried and then calcined. Subsequently, the surfaces O_{E} were treated with a filtration-enhancing powder and then thermally treated. The total loading of the filter with the filtration-enhancing powder was 12 g/L. The filter obtained in this way is referred to below as GPF3.

### Test of Filtration Efficiency and Exhaust Counterpressure

The two filters obtained in this way were then measured on a cold blowing test rig to determine the pressure loss across each filter (FIG. 3). At room temperature and a volume flow of 600 m³/h air, the counterpressure of the VGPF1 is 36.8 mbar, of the VGPF2 58.8 mbar, of the VGPF3 10.9 mbar, of the GPF1 32.1 mbar, of the GPF2 51.2 mbar, and of the GPF3 9.5 mbar.

In parallel, fresh filters VGPF1, VGPF2, VGPF3, GPF1, GPF2, and GPF3 were examined with regard to their particle filtration efficiency. For this purpose, the filters between two particle counters were measured. The GPF1, GPF2, and GPF3 filters according to the invention have a filtration efficiency of 91.7% (GPF1), 96.7% (GPF2), and 91.5% (GPF3) calculated from the particle values of the two particle counters, while the comparative filters only achieve a filtration efficiency of 79.5% (VGPF1), 94.4% (VGPF2), and 88.1% (VGPF3).

### Test of the Water Stability of the Powder According to the Invention

In this embodiment, a ground commercially available refractory aluminum oxide (d50: 2.0 μm) is coated with 100 wt.-% organic silicone resin binder Silres 603 (Wacker Chemie AG). To do this, the silicone resin is dissolved in acetone as a solvent, the aluminum oxide is added, and the silicone resin is applied by evaporating the solvent.

In order to test the water stability of the powder according to the invention, it is applied to a plate of commercially available monolithic porous cordierite and thermally treated in a convection oven at 550 °C for 2 hours. After cooling, the plate is examined under a microscope for open pores (dark spots), then held under running water for 20 s and then dried at 120 °C for 30 min. The dried plate is examined again under the microscope for open pores. If no pores are open after treatment with water, the powder is considered water-stable.

In summary, it can be seen that producing a filter by coating it with a catalytically active layer and then applying a filtration-enhancing powder, as opposed to applying a filtration-enhancing powder or using a commercially available flow-through filter substrate with a filtration-enhancing membrane and then applying a catalytically active layer, is even particularly advantageous in terms of filtration efficiency and counterpressure (FIG. 3).

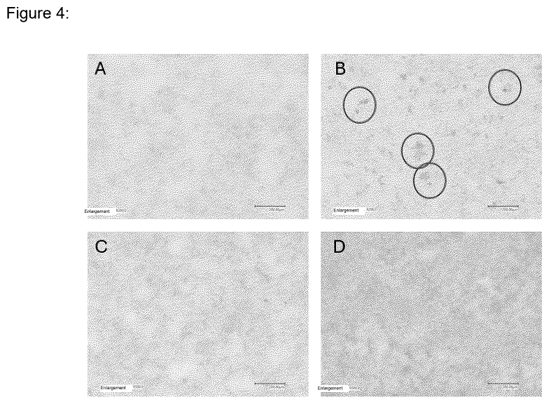

In addition to the advantages described above, a silicone resin-coated powder can be used in the method according to the invention to obtain a water-stable, filtration-enhancing powder coating. The filter according to the invention is therefore more stable and robust compared to water from the combustion process (FIG. 4).

1. A method for manufacturing a catalytically active particulate filter comprising a wall-flow filter substrate for reducing harmful components from the exhaust gas of internal combustion engines, wherein the wall-flow filter substrate has a length L and channels E and A which extend parallel between a first and a second end of the wall-flow filter substrate, which are separated by porous walls and form surfaces OE and OA, respectively, and wherein the channels E at the second end and the channels A at the first end are closed, characterized in that
in a first step, a dry powder comprising refractory metal compound particles coated with a silicone resin is produced; and
in a second, separate step, the surfaces OE of the catalytically active filter are coated with a dry powder-gas aerosol containing the powder from the first step;
and in a third step, the filter together with the powder is heated so that organic components are removed from the filter.

2. The method according to claim 1, characterized in that the refractory metal compound particles are selected from the group consisting of aluminum oxide, zirconium dioxide, cerium oxide, yttrium oxide, mullite, tin oxide, silicon nitride, zeolite, titanium dioxide, silicon dioxide, aluminum titanate, silicon carbide, cordierites, nesosilicates, phyllosilicates, technical silicates, chain silicates, group silicates, or mixtures thereof.

3. The method according to claim 1, characterized in that the refractory metal compound particles have an average particle diameter of 0.1 μm-20 μm (D50; Q3 distribution).

4. Method according to claim 1, characterized in that the refractory metal compound particles exposed to a silicone resin are not aggregated or agglomerated with each other.

5. The method according to claim 1, characterized in that a silicone resin selected from the group consisting of alkyl or aryl or alkyl and aryl-functionalized oligomers or polymeric silicone resins is taken for the exposure of the metal compound particles.

6. The method according to claim 1, characterized in that the exposure of the metal compound particles is such that the particles in a solvent suspension are brought together with the silicone resin and the solvent is subsequently vaporized.

7. The method according to claim 6, characterized in that this method step takes place in a spray dryer.

8. The method according to claim 1, characterized in that the powder-gas aerosol is sucked into the filter at a speed of 10 m/s-50 m/s.

9. A catalytically active particulate filter manufactured according to claim 1.

10. The catalytically active particulate filter according to claim 9, characterized in that up to 50% of the total mass of the powder is located in the porous walls of the wall-flow filter substrate.

11. The catalytically active particulate filter according to claim 9, characterized in that the powder has a mass of up to 50 g/L, based on the volume of the wall-flow filter substrate.

12. The catalytically active particulate filter according to claim 9, characterized in that the powder does not form a continuous coating on the surfaces OE.

13. The catalytically active particulate filter according to claim 9, characterized in that the filter has a catalytically active zone over a length of 30%-100% of the coatable length L of the filter.

14. A system for cleaning exhaust gases from, in particular, predominantly stoichiometrically operated internal combustion engines, which contains a catalytically active particulate filter of claim 10.

15. The system according to claim 14, characterized in that the particulate filter is arranged with its first end directly downstream of a three-way or oxidation catalytic converter close to the engine.

16. The system for cleaning exhaust gases according to claim 14, characterized in that, downstream of the wall-flow filter, there is at least one further catalyst selected from the group of three-way catalyst, oxidation catalyst, NOx storage catalyst, hydrocarbon trap, SCR catalyst, ammonia slip catalyst.

17. A method for exhaust gas purification of an internal combustion engine, in particular a predominantly stoichiometrically operated internal combustion engine, in which the exhaust gases of the engine are conducted over a wall-flow filter according to claim 10.

18. A method for exhaust gas purification of a predominantly stoichiometrically operated internal combustion engine, in which the exhaust gases of the engine are conducted over a system of claim 14.
